(19) United States
(12) Patent Application Publication
(10) Pub. No.: US 2017/0322948 A1
(43) Pub. Date: Nov. 9, 2017

(54) STREAMING DATA READING METHOD BASED ON EMBEDDED FILE SYSTEM

(71) Applicants: INSTITUTE OF ACOUSTICS, CHINESE ACADEMY OF SCIENCES, Beijing (CN); BEIJING INTELLIX TECHNOLOGIES CO. LTD., Beijing (CN)

(72) Inventors: Jun CHEN, Beijing (CN); Jinghong WU, Beijing (CN); Mingzhe LI, Beijing (CN); Hao FAN, Beijing (CN); Xiaozhou YE, Beijing (CN)

(73) Assignees: INSTITUTE OF ACOUSTICS, CHINESE ACADEMY OF SCIENCES, Beijing (CN); BEIJING INTELLIX TECHNOLOGIES CO. LTD., Beijing (CN)

(21) Appl. No.: 15/527,323

(22) PCT Filed: Mar. 12, 2015
(86) PCT No.: PCT/CN2015/074082

§ 371 Date: May 17, 2017

(30) Foreign Application Priority Data
Nov. 17, 2014 (CN) 201410653260.9

(51) Int. Cl. G06F 17/30; G06F 3/06; G06F 9/48

(52) U.S. Cl. CPC G06F 17/30168; G06F 17/30109; G06F 9/4881; G06F 3/061; G06F 3/0656; G06F 3/0674

(57) ABSTRACT

A streaming data reading method based on an embedded file system, including: receiving a request for reading streaming data, when the requested streaming data exists in a disk, creating a new reading task for the request, allocating a storage space to the newly created reading task, and initializing relevant parameters; decomposing the reading task into a plurality of sub-tasks, each sub-task being responsible for reading a piece of physically continuous data, and caching same; extracting the data from the sub-task cache, packaging same according to a streaming data format, submitting the data to a caller of this reading task once one block of data is packaged, and releasing this sub-task and triggering the next sub-task after submission; and when all sub-tasks are successfully completed, reporting the normal completion of the task to the task caller, and waiting for the task caller to end the current reading task.

### CROSS REFERENCE TO RELATED APPLICATIONS

This application is the national phase entry of International Application No. PCT/CN2015/074082, filed on Mar. 12, 2015, which is based upon and claims priority to Chinese Patent Application No. 201410653260.9 filed on Nov. 17, 2014, the entire contents of which are incorporated herein by reference.

### TECHNICAL FIELD

The present invention relates to the field of data storage technology, and particularly to a method for reading embedded file system-based streamed data.

### BACKGROUND OF THE INVENTION

With rapid development of the Internet and the industry of multimedia, various storage technologies and storage systems also have been developed rapidly. These storage systems provide convenient, rapid, efficient storage and access services for a vast amount of information over the Internet, and multimedia data information.

An embedded file system is provided with limited resources, and simply structured, thus general-purpose operating systems and file systems are rarely applied to the embedded file system due to the particularity and specificity thereof, but a file system is customized for the embedded file system in a specific application scenario. However the embedded file system can be applied in a wide range of scenarios, It is impossible that there is such a file system that can be applied to all kinds of embedded file systems scaling from as large as an embedded server to as small as an embedded set-top box, etc., thus an appropriate file system has to be selected and created in accordance with an application environment, objective and the like of the system. Different file systems manage their disks under different strategies, and read and write their data in different ways, therefore it is highly desirable in the prior art to solve the problem of high throughput and high concurrency of reading the data.

The rate of reading data by the file system depends on the IO performance of a lower-layer interface on one hand, and the scheduling efficiency in the file system itself on the other hand, but the concurrent capability of reading data by the file system is related to an internal scheduling mechanism.

### SUMMARY OF THE INVENTION

The objective of the present invention is to provide a method for reading embedded file system-based streamed data in order to provide a high-throughput and highly concurrent data reading service for an embedded streaming service.

In order to achieve the above object, an embodiment of the invention provides a method for reading embedded file system-based streamed data, the method comprises the steps of:

receiving a request for reading streamed data, and if the requested streamed data are saved on a disk, creating a new reading task for the request, and allocating a memory space for the newly created reading task and initializing the relevant parameters;

breaking down the reading task into a plurality of sub-tasks, each sub-task is responsible for reading and buffering a segment of physically consecutive data;

taking the data out of a buffer for the sub-task, encapsulating the data in a format of streamed data, submitting each block of data once encapsulated to an invoker of the current reading task, and releasing the current sub-task and triggering a next sub-task after the submission is completed; and

reporting a normal completion of the task to the invoker of the task after all the sub-tasks are completed successfully, and waiting for the invoker of the task to end the current reading task.

Preferably, the following steps are employed to determine whether the requested streamed data are saved on a disk: calculating a hash vale of a name of a requested file, upon the request for reading the streamed data is received, searching for the hash value, and then determining whether the requested data are saved on the disk.

Preferably, parameters of the request for reading the streamed data comprise a name of a file, a start offset and an end offset of the data to be read, and after the reading task is newly created for the request, the memory space is allocated for the reading task, and a hash value of the name of the file, and the start offset and the end offset of the data to be read are stored into the memory space allocated for the reading task, thus completing an initialization of the reading task.

Preferably, the breaking down the reading task into the plurality of sub-tasks comprises calculating a length of the reading task according to a start offset and an end offset of the task and breaking down the reading task into the plurality of sub-tasks in combination with information about the position on the disk where the streamed data to be read are stored; and concatenating all the sub-tasks in a linked list, and triggering the sub-tasks in a sequential order.

Preferably, after each sub-task is started, firstly a start sector and a length of streamed data to be read by the current sub-task are obtained, a memory space is allocated for the streamed data to be read according to the length of the streamed data to be read, and then which location on the disk where the streamed data are to be read is calculated according to the start sector, and finally a lower-layer interface is invoked to read the streamed data from specified segments on the specified disk.

Preferably, after each sub-task is completed, a bottom-layer interface sends a message notifying the file system of a success or a failure of the current sub-task, and the file system takes the data out of a buffer of the current sub-task upon a successful completion message of the sub-task is received.

Preferably, when each sub-task is performed, a memory space for buffering data read out of the disk is pre-allocated for the streamed data to be read; and wherein the length of the streamed data to be read, as identified by each sub-task is an integral multiple of a size of a sector on the disk, and the sub-task reads the data out of the disk in an asynchronous, non-blocking IO mode.

Preferably, after a previous sub-task is completed successfully, a message is sent to the file system, and the file system copies data from a data buffer area of the sub-task into a newly allocated memory upon the reception of the message, encapsulates the data in the format of streamed data, submits the encapsulated data to the invoker of the current reading task, and then triggers a next sub-task until all the sub-tasks are ended.

Preferably, for a pending reading task, the task is ended ahead by adjusting an end offset of the task forward; and for a task that all the data are read, the end offset of the task is adjusted backward to append data to be read.

Preferably, during each sub-task is performed, an end offset of the reading task may be changed as needed, and if a new end offset of the task is less than an end offset of the current sub-task, a current update is ignored; otherwise, an end offset of data to be read among parameters of the task is replaced with the new end offset of the task, and a sub-task according to the new end offset of the task is regenerated.

The invention is advantageous over the prior art in that:

1. High efficiency in that the invention breaks down a task into sub-tasks, such that each sub-task reads a segment of both logically and physically consecutive data, meanwhile a length of data to be read by a single sub-task is limited, thus improving the efficiency of reading the data; and

2. High concurrency in that an asynchronous reading mechanism is employed, such that the sub-task returns immediately after the lower-layer reading interface is invoked, without being blocked in any data reading process; and multi-core cooperation is also enabled, more specifically, after the sub-task is completed successfully, the lower-layer interface sends a message reporting the successful completion of the sub-task, and a next sub-task is further driven by this message, and the next sub-task may be performed by another core. In this way, high concurrent performance of reading the streamed data can be guaranteed.

Furthermore, the present invention also allows a user during reading the data to change an end offset, thereby enabling a larger number of operating modes of the user, therefore the invention has significant advantage in an application scenario of a streaming service.

### BRIEF DESCRIPTION OF THE DRAWINGS

FIG. 1 is a schematic flow chart of a method for reading embedded file system-based streamed data according to an embodiment of the present invention;

FIG. 2 is a flow chart of driving by message in the embodiment of the invention illustrated in FIG. 1;

FIG. 3 is a flow chart of a reading task in the embodiment of the invention illustrated in FIG. 1; and

FIG. 4 is a schematic diagram of a representation of a linked list of sub-tasks in the embodiment of the invention illustrated in FIG. 1.

### DETAILED DESCRIPTION OF THE INVENTION

The present invention will be described below in details in conjunction with the drawings and the embodiments thereof such that the advantages above of the invention are more explicit.

In view of the problems of low efficiency of reading data and concurrent capability in the existing embedded streaming service, an embodiment of the invention proposes a method for reading embedded file system-based streamed data, which improves the efficiency of reading data by decomposing a task, ensures highly concurrent reading of the streamed data by employing an asynchronous reading mechanism, and also allows a user to change an end offset during the reading of data, thereby enabling a larger number of operating manners of the user, therefore this method will be significantly advantageous in an application scenario of a streaming service.

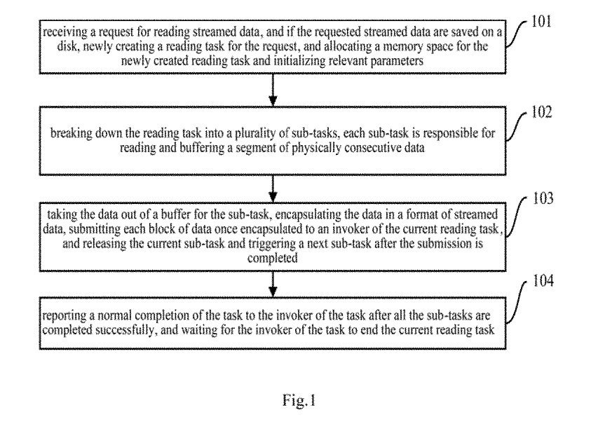

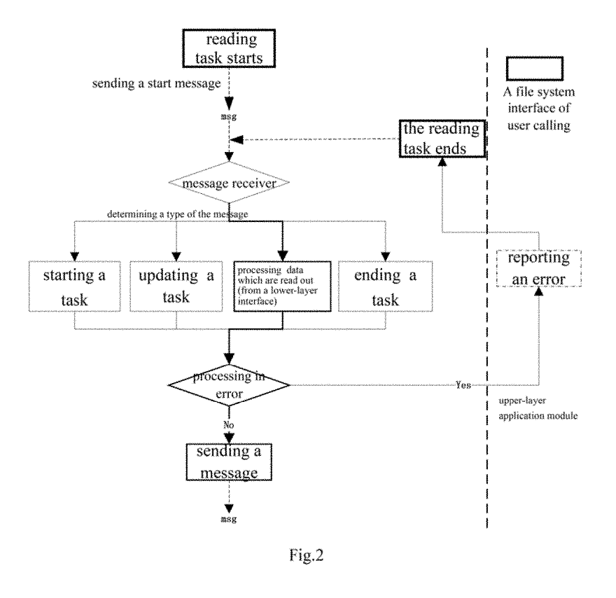

FIG. 1 is a schematic flow chart of a method for reading embedded file system-based streamed data according to an embodiment of the invention, and FIG. 2 is a flow chart of driving by message. In an embodiment of the invention, an event driving mechanism is employed that all the events are driven by taking a message as a carrier, wherein starting of a task, updating of a task, processing of data which are read out, and ending of a task are driven by a message. The embodiments of the invention will be described below in details with reference to FIG. 1 and FIG. 2. As illustrated in FIG. 1, the method includes steps 101 to 104.

At step 101, a request for reading streamed data is received, and a reading task for the request is newly created if the requested streamed data are present on a disk, and a memory space for the newly created reading task is allocated and relevant parameters are initialized.

Specifically, a message receiver is responsible for receiving all the messages, determining types of the received messages, and responding to the messages according to their types, which include starting of a task, updating of a task, processing of data which are read out and ending of a task. After a user invokes successfully an interface provided by a file system to request for reading the data, the file system may issue a start message, and after the message receiver receives the start message, the file system performs a first branch “Starting of a task” in FIG. 2, wherein “Starting of a task” is to create a reading task for a new request.

Preferably when a request for reading streamed data is received, firstly it is determined whether the requested streamed data are present by: calculating a hash value of a name of a requested file and searching for the hash value, and if the hash value is found, that is, the requested streamed data are saved on a disk, then newly creating a reading task for the request immediately, allocating a memory space for the new task and initializing relevant parameters; if the requested streamed data are not saved on any disk, then notifying the user of a failure of the reading request.

Parameters for a request for reading streamed data include a name of a file, a start offset and end offset of the data to be read, and the like. After a reading task is newly created, a memory space is allocated for the reading task, and a hash value of the name of the file, the start offset and the end offset of the data to be read, and other information are stored into the space of the task, thus completing the initialization of the task.

At step 102, the reading task is broken down into a plurality of sub-tasks, each of which is responsible for reading and buffering a segment of physically consecutive data.

Specifically, after the reading task is created successfully, the file system obtains metadata information of the requested file, and divides the reading task into the sub-tasks in accordance with the start offset of the streamed data to be read, and the length of the data to be read, in combination with information about the position where the requested streamed data are stored on the disk, wherein the sub-tasks into which the reading task is divided are logically consecutive, each of the sub-tasks is responsible for reading a segment of both logically and physically consecutive data, and data read out by adjacent sub-tasks may not necessarily be physically consecutive.

Preferably after the reading task is newly created successfully, the start offset of the current reading task and the length of the task are extracted, file index information corresponding to the streamed data to be read is inquired, such that the information about the position on the disk where the streamed data are stored can be obtained. The reading task is broken down into several sub-tasks through the calculation of the length of the task and the start offset in combination with the information about the position on the disk where the streamed data are stored, wherein each of the sub-tasks is responsible for reading a segment of both logically and physically consecutive data, and the length of the data is an integral multiple of a size of a sector. Data to be read out by adjacent sub-tasks are logically consecutive, but may not be physically consecutive as a piece of streamed data is not often to be stored consecutively on a disk. The reading task is divided into the sub-tasks for the purpose of reading each segment of physically consecutive data out of the disk. Meanwhile in order to enable the streamed data to be read efficiently, the length of data for a sub-task is limited so that the length of data to be read by a single sub-task is not too large. Information of the sub-tasks are stored in a way of linked list in which each node includes a start sector from which data are read by the current sub-task, and the length of the data to be read by the current sub-task, wherein the length is represented by the number of sectors. After the task is broken down, the first sub-task is actively triggered.

After a sub-task is triggered, firstly a start sector from which data are to be read by the current sub-task, and the length of the data to be read are obtained, wherein the length of the data to be read by the current sub-task is calculated from the number of sectors, and the size of a sector. A memory space is allocated for the current sub-task according to the calculated length in order to buffer data to be read out of a disk, and then the disk where the streamed data to be read by the current sub-task are stored is found according to the sequence number of the start sector. The lower-layer interface is invoked, and the sequence number of the disk, the sequence number of the start sector, the number of sectors, an address where the streamed data to be read are buffered, and other parameters are imported, such that the specified data can be read from the specified disk.

At step 103, the data taken out of the sub-task buffer are encapsulated in a format of streamed data, each block of data once encapsulated is submitted to an invoker of the current reading task, and the current sub-task is released after the submission is completed, and a next sub-task is triggered.

Specifically after the sub-tasks are generated, the file system triggers the first sub-task on its own initiative. After the sub-task is started, the file system first obtains the parameters of the sub-task, including the sequence number of the start sector from which the data are to be read, and the number of sectors from which the data are to be read, calculates the amount of data to be read by the current sub-task according to the size of a sector and the number of sectors from which the data are to be read, allocates a memory space for buffering the data to be read according to the amount of data, and then calculates the sequence number of the disk where the start sector to be read by the current sub-task is, and finally invokes the lower-layer reading interface to read the data out of the specified disk, and imports the sequence number of the disk, the sequence number of the start sector, the number of sectors and the other parameters. The sub-task returns immediately after invoking the lower-layer interface, rather than returns after all the data are read out. After all the data are read out of the buffer for the sub-task, the lower-layer interface sends a message reporting a successful completion of the sub-task. The message receiver, upon the reception of the message, determines that the type of the message is a sub-task completion notification message, then the file system proceeds to a third branch “processing data which are read out” in FIG. 1, and this branch is the main branch in the whole reading task. Whenever a successful completion message of a previous sub-task is received, a next sub-task is triggered by this message. The above flow is repeated cyclically until all the sub-tasks are completed, or some sub-task fails.

Preferably the sub-task reads the data from the disk in an asynchronous, non-blocking IO mode, that is, returns immediately after the lower-layer interface is invoked, without being blocked in any IO process. This mechanism is applicable to multi-core cooperation and facilitates high concurrency of a number of tasks, and efficient reading of streamed data. After all the data corresponding to the current sub-task are read out, the lower-layer interface may send a message reporting whether the sub-task is completed successfully. Upon a successful completion message of the sub-task is received, the file system takes the data out of the buffer of the sub-task, encapsulates the data in the format of the streamed data, and submits each block of data once encapsulated to the invoker of the current reading task until all the data read out by the current sub-task are submitted, or the remaining data are temporarily not sufficient to be submitted. The remaining data which are not sufficient to be submitted are temporarily buffered, and after the data are read out of the disk by the next sub-task, the buffered data are taken out, encapsulated and submitted.

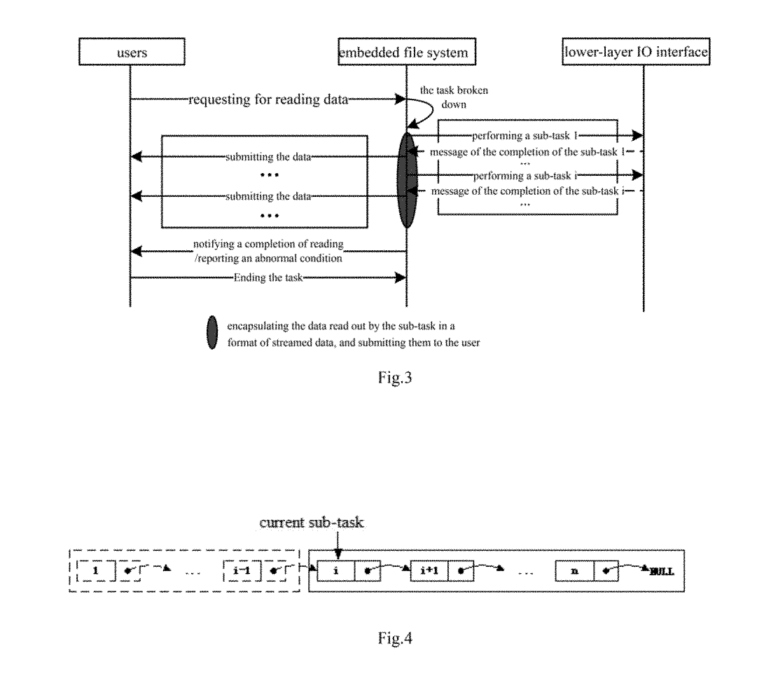

FIG. 3 is a flow chart of a reading task in the embodiment of the invention illustrated in FIG. 1, wherein data which are read out are processed, that is, the data are encapsulated in the format of streamed data into respective blocks of data with some fixed length, the value of which is relevant to a particular application scenario of a streaming service. After data read out by a sub-task are encapsulated in the format of streamed data, if there are remaining data which are not sufficient to be encapsulated into one block of streamed data to be submitted to the user, the remaining data of the sub-task will be buffered, and further encapsulated after the next sub-task is completed. This flow is repeated cyclically until all the sub-tasks are completed. After all the sub-tasks are completed, it is possible that there are remaining data which are still not sufficient to be encapsulated into the last normal block of data after the data are encapsulated in the format of streamed data. Since this segment of data is the last segment of data throughout the reading task, and there are no subsequent data, the last block of data which is not sufficient to be encapsulated into one normal block of data will be still submitted to the user.

During the reading task is performed, the user can change the end offset of the reading task as needed. For example, if the user finds that he or she only needs to read a part of the data instead of the entire file, the user may adjust the end offset of the task forward. The user may invoke an interface provided by the embedded file system for the user to update parameters of a task. After the interface is invoked, the file system may send a message for updating the task. After the message is received by the message receiver, the file system may perform the second branch “updating a task” in FIG. 2.

The original end offset of the task is compared with the new end offset of the task, and if the new end offset of the task is less than the original end offset of the task, then the task may be updated forward, that is, the task will be ended ahead. The file system obtains an offset of the data being read by the current sub-task, and if the new end offset of the task is less than the offset of the data to be read by the current sub-task, the task fails to be updated and the current update request is ignored directly; or if the new end offset of the task is larger than the offset of the data to be read by the current sub-task, the end offset of data to be read among the parameters of the task is replaced with the new end offset of the task, sub-tasks are regenerated according to the new end offset, and the linked list of sub-tasks is updated.

At step 104, a normal completion of the task is reported to an invoker of the task after all the sub-tasks are completed successfully, and the invoker of the task is waited to end the current reading task.

Specifically, if the sub-task fails, the data which are read out are processed in error, or the task is updated in error, the file system may report an abnormal condition to the user on its own initiative. If all the sub-tasks are completed successfully, and the data which are read out are processed normally, the file system may report the normal completion of the reading task to the user. The user ends the task on his or her initiative upon the reception of the abnormality or completion report from the file system. An interface for ending the task is also implemented by the file system to be invoked by the user. In principle, the user can end a reading task on his or her own initiative at any time.

Preferably the sub-task is not completed until the data which are read out are encapsulated and submitted. Upon the sub-task is ended, a task space and data space are released, wherein the task space is released by deleting the current head node in the linked list of sub-tasks, and the data space refers to a memory space allocated for buffering the data which are read out when the sub-task is started. The next sub-task is triggered only when the previous sub-task is completed successfully. If some sub-task fails, the file system may report an abnormality condition of the task to the invoker of the task on its own initiative upon the reception of a failure message. Upon all the sub-tasks are completed successfully, the file system may also report the normal completion of the task to the invoker of the task, and wait for the invoker of the task to end the current reading task.

The invoker of the task can invoke an interface function provided by the file system to end the task on its own initiative, upon the reception of the abnormality or completion of the task reported by the file system, or the invoker of the task can even end the task on its own initiative during the task is performed. In addition, a parameter of the ongoing task can be updated in an embodiment of the invention. For a pending task, the task can be ended ahead by adjusting the end offset of the task forward, and for a task that all the data are read, the end offset of the task can be adjusted backward to append data to be read. With this method, the user is provided with flexible and variable operating modes appropriate for a number of application scenarios of streamed data.

FIG. 4 is a schematic diagram of a representation of a linked list of sub-tasks in the embodiment of the invention illustrated in FIG. 1. As illustrated in FIG. 4, each node in the linked list represents a sub-task, and the node includes parameters of the sub-task, such as a sequence number of a start sector, the number of sectors, a sequence number of a disk, etc. The linked list is generated when the task is started. Whenever a sub-task is completed, the head node of the linked list is released, and a pointer “Current sub-task” is pointed to a next sub-task. A node in a dotted box in FIG. 4 represents a completed sub-task. Each time a sub-task is triggered, parameters of the sub-task are obtained using the pointer “Current sub-task”, wherein the pointer “Current sub-task” points to the head node of the linked list of tasks all the time. After the end offset of the task is updated, the linked list of tasks before the parameter is updated is first deleted, and then a new linked list of tasks is recalculated and generated according to the new end offset of the task, and the current state of the task.

The embodiments of the invention ensure that, by breaking a reading task down into sub-tasks, each sub-task can read a segment of both logically and physically consecutive data, meanwhile the length of data to be read by a single sub-task is limited, thus improving the efficiency of reading the data; employs an asynchronous reading mechanism, such that the sub-task returns immediately after the lower-layer reading interface is invoked, without being blocked in any data reading process; and also enables multi-core cooperation, more specifically, after the sub-task is completed successfully, the lower-layer interface sends a message reporting the successful completion of the sub-task, and a next sub-task is further driven by this message, and the next sub-task may be performed by another core. In this way, high concurrent performance of reading the streamed data can be guaranteed.

Finally, it should be explained that the aforementioned embodiments are merely used for illustrating, rather than limiting the technical solutions of the present invention. Although the present invention has been described in detail with reference to the embodiments, those skilled in the art will understand that modifications or equivalent substitutions can be made to the technical solutions of the present invention without departing from the scope and spirit of the technical solutions of the present invention, and thereby should all be encompassed within the scope of the claims of the present invention.

1. A method for reading embedded file system-based streamed data, comprising:
receiving a request for reading streamed data, and if the requested streamed data are saved on a disk, creating a reading task for the request, and allocating a memory space for the created reading task and initializing relevant parameters;
breaking down the reading task into a plurality of sub-tasks, wherein each sub-task is responsible for reading and buffering a segment of physically consecutive data;
taking the data out of a buffer for each sub-task, encapsulating the data in a format of streamed data, submitting each block of data once encapsulated to an invoker of the reading task, and releasing a current sub-task and triggering a next sub-task after the submission is completed; and
reporting a normal completion of the task to the invoker of the task after all the plurality of sub-tasks are completed successfully, and waiting for the invoker of the task to end the reading task.

2. The method according to claim 1, wherein following steps are employed to determine whether the requested streamed data are saved on the disk:
calculating a hash value of a name of a requested file upon the request for reading the streamed data is received, searching in metadata of the file system for the hash value, and then determining whether the requested data are saved on the disk.

3. The method according to claim 1, wherein the relevant parameters for the request for reading the streamed data comprise a name of a file, and a start offset and an end offset of the data to be read, and after the reading task is created for the request, a memory space is allocated for the reading task, and a hash value of the name of the file, and a start offset and an end offset of the data to be read are stored into the memory space allocated for the reading task, thus an initialization of the reading task is completed.

4. The method according to claim 1, wherein the breaking down the reading task into the plurality of sub-tasks comprises:
calculating a length of the reading task according to a start offset and an end offset of the task, and breaking down the reading task into the plurality of sub-tasks in combination with information about a position on the disk where the streamed data to be read are stored; and
concatenating all the sub-tasks in a linked list, and triggering the sub-tasks in a sequential order.

5. The method according to claim 1, wherein after said each sub-task is started, firstly a start sector and a length of streamed data to be read by a current sub-task are obtained, a memory space is allocated for the streamed data to be read according to the length of the streamed data to be read, and then a location on the disk where the streamed data are to be read is calculated according to the start sector, and finally a lower-layer interface is invoked to read the streamed data from specified segments on the specified disk.

6. The method according to claim 1, wherein when each sub-task is performed, a memory space for buffering data to be read out of the disk is pre-allocated for the streamed data to be read; and wherein the length of the streamed data to be read, as identified by said each sub-task is an integral multiple of a size of a sector on the disk, and the sub-task reads the data out of the disk in an asynchronous, non-blocking IO mode.

7. The method according to claim 1, wherein after the current sub-task is completed, a bottom-layer interface sends a message notifying the file system of a success or a failure of the current-sub-task, and the file system takes the data out of a buffer of the current sub-task upon a successful completion message of the current sub-task is received.

8. The method according to claim 1, wherein after a previous sub-task is completed successfully, a message is sent to the file system, and the file system copies data from a data buffer area of the previous sub-task into a newly allocated memory upon the reception of the message, encapsulates the data in the format of streamed data, submits the encapsulated data to the invoker of the reading task, and then triggers a next sub-task until all the plurality of sub-tasks are ended.

9. The method according to claim 1, wherein for a pending reading task, the task is ended ahead by adjusting an end offset of the task forward; and for a task that all the data are read, the end offset of the task is adjusted backward to append data to be read.

10. The method according to claim 1, wherein during said each sub-task is performed, an end offset of the reading task may be changed as needed, and if a new end offset of the task is less than an end offset of a current sub-task, a current update is ignored; otherwise, an end offset of data to be read among parameters of the task is replaced with the new end offset of the task, and a sub-task according to the new end offset of the task is regenerated.
